(19) United States
(12) Patent Application Publication
(10) Pub. No.: US 2005/0152004 A1
(43) Pub. Date: Jul. 14, 2005

(54) Method and apparatus to process and edit images and to print the processed and edited images and edited images at a time

(76) Inventor: Ji-sub Park, Suwon-si (KR)

Correspondence Address: STANZIONE & KIM, LLP, 1740 N STREET, N.W., FIRST FLOOR, WASHINGTON, DC, 20036, US

(21) Appl. No.: 11/030,898

(22) Filed: Jan. 10, 2005

(30) Foreign Application Priority Data
Jan. 10, 2004 (KR) 2004-1815

(51) Int. Cl. G06K 15/02; G06F 3/12

(52) U.S. Cl. 358/1.18; 358/452

(57) ABSTRACT

A method of processing and editing a plurality of images and printing the processed and edited images at a time using a printing apparatus includes receiving an image to print selected by a user, receiving an input by the user regarding a predetermined selection item to process and edit the selected image, reading out the selected image, and processing and editing the image according to the selection item, if the user further selects a second image to print, processing and editing the further selected image, and printing all images processed and edited according to an input to print the images selected, and processed and edited.

### CROSS-REFERENCE TO RELATED APPLICATIONS

This application claims the priority of Korean Patent Application No. 2004-1815, filed on Jan. 10, 2004, in the Korean Intellectual Property Office, the disclosure of which is incorporated herein in its entirety by reference.

### BACKGROUND OF THE INVENTION

1. Field of the Invention

The present general inventive concept relates to an apparatus to output documents or images, such as a printer, and more particularly, to an apparatus and method of processing and editing a plurality of images and printing the processed and edited images at a time, not sequentially processing, editing, and printing images one by one.

2. Description of the Related Art

Digital cameras are widely being used to take images and the images are frequently output as photo images using a device such as a photo printer. The images taken by a digital camera are stored in a memory card installed in the digital camera. As the memory card is connected to a computer, the images stored in the memory card are transmitted to the computer and printed using a printer connected to the computer. In doing so, a user edits the images using an image processing program installed on the computer and prints the edited images through the printer.

To avoid any inconvenience of a user needing a computer to print images taken by a digital camera, some printers have a function of directly reading a memory card installed in the digital camera to print the images stored in the memory card, by inserting the memory card in a memory installation port provided in the printer, without using the computer. The printer having the function of directly reading the memory card of the digital camera may provide the user with a simple image editing function.

To use the image editing function provided by the printer, after images to be printed are read from the memory card of the digital camera, the images are edited using the image editing function provided by the printer and then the edited images are printed. If only a few images to be printed are present, there is no great inconvenience. However, when the number of image to be printed is large, the user needs to wait until the edited image is printed and, after printing, the next image is read from the memory card and the same or similar editing process as one with respect to the previous image must be performed to print the next image. The above editing work must be repeated with respect to all images to be edited and printed among the photographed images.

When the number of images to be printed through the printer is large, the user repeats the same process which is simple and boring, and which inconveniences the user using the printer to print images.

### SUMMARY OF THE INVENTION

To solve the above and/or other problems, the present general inventive concept provides a method and apparatus to process and edit a plurality of images and to print the processed and edited images at a time by setting items to be edited for each image and outputting the edited images, not editing an image to be printed using a predetermined function and printing the edited image and, after printing the image, editing and printing a next image, and repeating the same.

Additional aspects and advantages of the present general inventive concept will be set forth in part in the description which follows and, in part, will be obvious from the description, or may be learned by practice of the general inventive concept.

The foregoing and/other aspects and advantages of the present general inventive concept may be achieved by providing a method of processing and editing a plurality of images and printing the processed and edited images at a time using a printing apparatus, the method comprising receiving a first and a second images to print selected by a user, receiving an input by the user regarding a predetermined selection item to process and edit the first and second images, reading out the first and second images, and processing and editing the first and second images according to the selection item, and printing the first and second images processed and edited according to an input to print the first and second images selected, and processed and edited.

The foregoing and/and other aspects and advantages of the present general inventive concept may also be achieved by providing a method of processing and editing a plurality of images and printing the processed and edited images at a time using a printing apparatus, the method comprising receiving an image to print selected by a user, receiving an input by the user regarding a predetermined selection item to process and edit the selected image, reading out the selected image, processing and editing the read image according to the selection item, and displaying the processed and edited image to the user, generating a print information list including the selected image and the selection item to process and edit the selected image, if the user further selects another image to print, generating another print information list corresponding to the further selected image to print by repeating the operations of receiving, reading out, processing and editing, and displaying, and printing all images processed and edited and displayed to the user at a time according to the print information list, another print information list and an input to print the images selected.

The foregoing and/or other aspects and advantages of the present general inventive concept may also be achieved by providing an apparatus to process and edit a plurality of images and to print the processed and edited images at a time, the apparatus comprising an image storing portion to store image data corresponding to first and second images, a user input portion to receive an input to select the first and second images from the image storing portion to print from a user, an input to select a predetermined selection item to process and edit the first and second images, and an input to perform printing, a processing and editing portion to read out the first and second images selected through the user input portion from the image storing portion and to process and edit the first and second images according to the selection item to process and edit, and a print portion to print the first and second images processed and edited by the processing and editing portion when the input to print the first and second processed and edited is input through the user input portion.

The foregoing and/or other aspects and advantages of the present general inventive concept may also be achieved by providing an apparatus to process and edit a plurality of images and to print the processed and edited images at a time, the apparatus comprising an image storing portion to store image data corresponding to first and second images, a user input portion to receive an input to select the first and second images from the image storing portion to print from a user, an input to select a predetermined selection item to process and edit the first and second images, and an input to perform printing, a processing and editing portion to read out the first and second imaged selected through the user input portion from the image storing portion and to process and edit the first and second images according to the selection item, a display portion to display the first and second images selected by the user and the first and second images processed and edited by the processing and editing portion, to the user, a print information list generating portion to generate a print information list including the processed and edited first image and the selection item and the processed and edited second images and the selection item, and a print portion to print the first and second images processed and edited by the processing and editing portion according to the print information list and the input to print the image processed and edited through the user input portion.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flow chart illustrating a method of processing and editing a plurality of images and printing the processed and edited images at a time according to an embodiment of the present general inventive concept;

FIG. 2 is a block diagram illustrating an apparatus to process and edit a plurality of images and to print the processed and edited images at a time according to an embodiment of the present general inventive concept;

FIG. 3A is a view in which an image selected by a user is displayed on a screen of a display portion in the apparatus of FIG. 2;

FIG. 3B is a view in which the image selected by the user is displayed in one part of the display portion and a frame to be applied to the image is displayed in the other part of the display portion in the apparatus of FIG. 2;

FIG. 3C is a view in which a resultant image to which a selected frame is applied is displayed in one part of the display portion and the original image before the frame is applied is displayed in the other part of the display portion in the apparatus of FIG. 2;

FIG. 3D is a view in which a resultant image that is processed and edited by the selection of a user is displayed in one part of the display portion and the original image is displayed in the other part of the display portion in the apparatus of FIG. 2;

FIG. 4 is a flow chart illustrating a method of processing and editing a plurality of images and printing the processed and edited images at a time according to another embodiment of the present general inventive concept;

FIG. 5 is a block diagram illustrating an apparatus to process and edit a plurality of images and to print the processed and edited images at a time according to another embodiment of the present general inventive concept; and

FIG. 6 shows examples of a print information list generated in the apparatus of FIG. 5.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

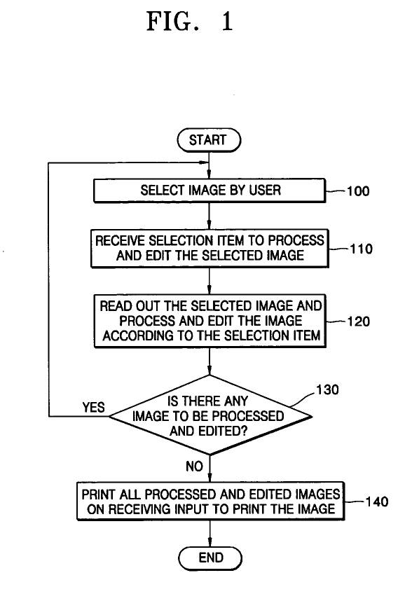

Referring to FIG. 1, a method of processing and editing a plurality of images and printing the processed and edited images at a time according to an embodiment of the present general inventive concept includes receiving an input to print selected by a user (operation 100), receiving an input on a predetermined selection item to process and edit the image selected at operation 100 (operation 110), reading out the selected image and processing and editing the same according to the selection item (operation 120), and determining whether there is another image to be processed and edited (operation 130). If there is no image to be processed and edited, all processed and edited images are printed upon a user's request to print (operation 140). If there is another image to be processed and edited, the operations 110 through 120 are repeated after the another image is received.

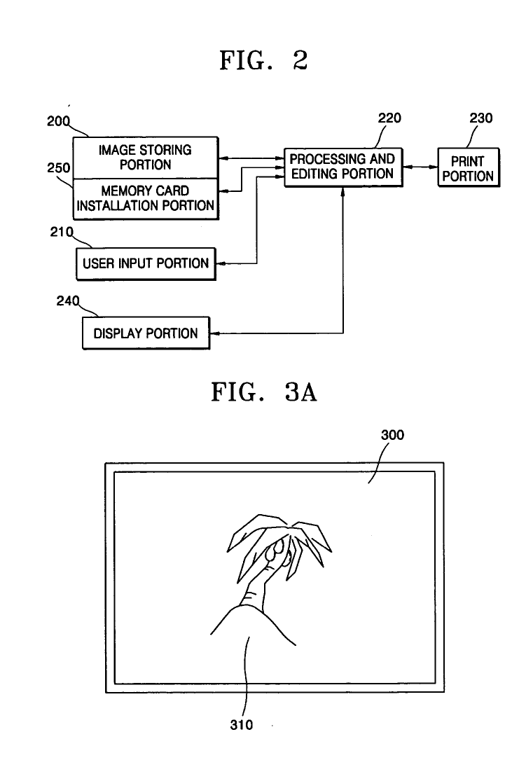

FIG. 2 is a block diagram illustrating an apparatus to process and edit a plurality of images and to print the processed and edited images at a time according to an embodiment of the present general inventive concept. Referring to FIG. 2, the apparatus to edit and print an image includes an image storing portion 200 to store image data corresponding to the images, a user input portion 210 to receive a user's selection of the image data stored in the image storing portion 200, a predetermined selection item to process and edit the images, and an instruction to print the images, a processing and editing portion 220 to read out the images selected through the user input portion 210 from the image storing portion 200 and to process and edit the images according to the selection item to process and edit the images, and a print portion 230 to print the images processed and edited by the processing and editing portion 220 upon receiving an input to print the processed and edited image received through the user input portion 210.

The apparatus further includes a display portion 240 to display the image selected by the user and/or the processed and edited image by the processing and editing portion 220 to the user and a memory card installation portion 250 for inserting a predetermined memory card and reading out data therefrom.

The method of FIG. 1 can be performed in an outputting (printing) apparatus, such as a printer or an all-in-one apparatus having a printing function, in particular, in a photo printer outputting photographed data as a photo. Also, the apparatus of FIG. 2 can be embodied as the printer or the all-in-one apparatus having a printing function, in particular, the photo printer.

In the following description, the printing apparatus according to the present general inventive concept may be referred to as a photo printer (hereinafter, referred to as “printer”). In the following the description, no other description on applicability of the present general inventive concept to other printing apparatuses will be added since the present general inventive concept can be applied to the other printing apparatuses according to a type thereof without altering the gist of the present general inventive concept. To clarify the gist of the present general inventive concept, no additional description will be given to the well-known function or structure of the apparatus such as a printer.

A user selects an image stored in the image storing portion 100 through the use input portion 210 (operation 100). Digital data (photographed image data) of the image to be printed is stored in the image storing portion 200 and the user selects the image to be printed or processed and edited by selecting a file of the image stored in the image storing portion 200.

The image storing portion 200 may be a memory device included in the printer. The photographed image data is transferred to the image storing portion 200 of the printer through a computer connected to the printer so that the user can select the image data stored in the printer.

Alternatively, the user may select the image stored in a storing medium such as a hard disk of the computer connected to the printer. To this end, the user may select an image stored in the computer connected to the printer at operation 100. The processing and editing portion 220 reads out the image stored in the computer connected to the printer at operation 120. In this case, the image storing portion 200 is embodied using a medium such as the hard disk of the computer connected to the printer.

Alternatively, a memory device such as a flash memory card where data photographed using equipment, such as a digital camera, is stored is inserted in the printer, the user selects the image stored in the flash memory card, and the processing and editing portion 220 can read out the image from the flash memory card. To this end, the image storing portion 200 includes the memory card installation portion 250 to insert a predetermined memory card and to read out data. When the user selects the image stored in the memory card inserted in the memory card installation portion 250, the processing and editing portion 220 reads out the image from the memory card.

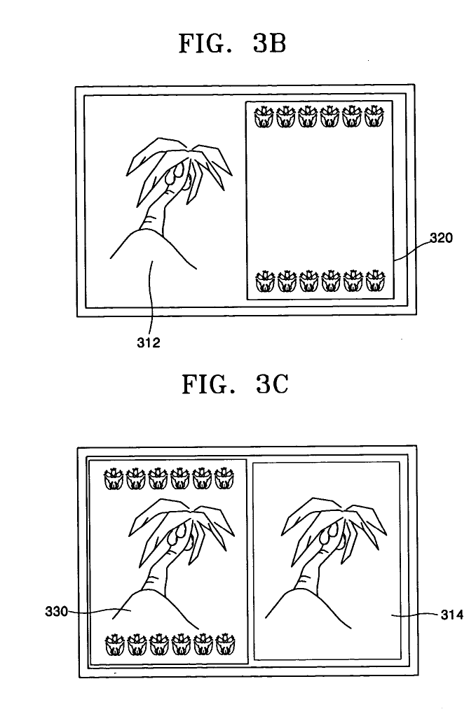

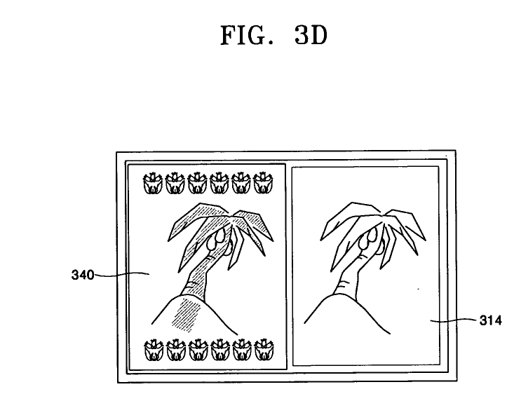

The image selected by the user is displayed on the display portion 240 so that the user can identify the image selected by the user. The display portion 240 can be embodied using devices including an LCD. FIG. 3A illustrates that an image 310 selected by the user is displayed on a screen 300 of the display portion 240.

The user input portion 210 can be embodied by a key pad (not shown) installed on an outer surface of the printer for the user to input information, a unit such as an LCD screen displaying an input menu and information input by the user, and an appropriate program executing on the printer. It is possible that the program operating in the printer can be embodied by a program such as firmware whose codes are executable by being stored in a memory device such as a ROM included in the printer.

An LCD window of the user input portion 210 may use an LCD screen of the display portion 240. The display portion 240 can be embodied using an additional LCD screen for input by the user.

The user selects an item to process and edit an image through the user input portion 210. When images stored in at least one of the image storing portion 200, the memory card inserted in the memory card installation portion 200, and the storing medium of the computer connected to the printer, are indicated by file names through the LCD screen of the user input portion 210, the user may select at least one desired image of the images using the key pad. When the selected image and the selection items to process and edit the image are displayed on the LCD screen of the user input portion 210, the desired image and at least one of the selection items can be selected using the key pad.

The selection items to process and edit the image are, for example, a frame setting to apply a frame effect to a printed image, reduction or expansion (enlargement) of the image, changing the contrast of the image, adjusting the brightness of the image, and changing the brightness of the image. In addition, processing and editing of an image by various image processing methods are possible.

The processing and editing portion 220 reads out the image selected by the user and processes and edits the same according to the user selection item (operation 120). For example, while seeing the selected image displayed on the display portion 240, the user selects an image contrast adjustment as the selection item for image processing and editing, and then the contrast of the image is adjusted through the key pad of the user input portion 210. The processing and editing portion 220 displays the result of the image contrast adjustment performed by the user on the display portion 240 so that the user can see the result. When the user confirms or selects the result, the processing and editing portion 220 temporarily stored the result.

FIG. 3B is a view in which an original image 312 selected by a user is displayed in a part of the display portion 240, and a frame 320 to be applied to the original image 312 is displayed in the other part of the display portion 240. The frame 320 may be changed into other shapes according to a user's input through the key pad of the user input portion 210. The user finally selects a desired frame using a selection key (not shown) of the key pad.

FIG. 3C is a view in which a resultant image to which the selected frame 320 is applied is displayed in one part (first area) 330 of the display portion 240 and the original image before the frame 320 is applied is displayed in the other part (second area) 314 of the display portion 240. When the result of processing and editing the image selected according to the user's selection item is displayed to the user, the original image 312 that is not processed and edited may be displayed to the user together. Accordingly, the user compares the processed and edited image with the original image 312 and may confirm or cancel the selected processing and editing item. In a case of FIG. 3C, the first area 330 for the processed image is an active window whose boundary is indicated thick and dark while the second area 314 for the original image 312 that is not processed has a boundary that is indicated thin and light, so as to improve the user's convenience.

FIG. 3D is a view in which, when the user selects processing of darkening the image with the frame 320 and the processing and editing portion 220 processes the image according to the selection item, a resultant image 340 is displayed in one part of the display portion while the original image 314 is displayed in the other part of the display portion. Accordingly, after the frame processing, the resultant image 340 may be processed or edited to be darker.

To this end, at operations 110 and 120, when the selection item to process and edit the selected image at operation 100 is multiple, the selection item to process and edit the image selected by the user is input and the result of the processing and editing of the selected image according to the input selection item is displayed to the user. The displayed result is confirmed by the user. When another selection item is input by the user, the newly input selection item is added to the previously processed and edited image according to the previously input selection item. The processed and edited image is displayed to the user to receive confirmation from the user.

The processing and editing portion 220 may not need to store all processed and edited images according to the processing and editing items that the user selected because the user doe not wish to print all the processed and edited resultants. For this purpose, at operation 120, the resultant image that is processed and edited according to the selection item is displayed to the user to receive confirmation from the user. It is efficient in view of a storing space to temporality store only the images which received the confirmation of the user for later work.

When the user confirms the image in the state of FIG. 3D, the resultant image 340 that is processed and edited is temporarily stored for printing.

The processing and editing portion 220 determines whether the user selects another image after processing and editing is completed to the image selected by the user (operation 130). If the user selects the another image to be processed and edited, operations 110 through 120 are repeated until the user's selection and processing and editing of a desired image are completed. Then, the images whose completion of processing and editing is confirmed by the user are all temporarily stored.

When the user inputs a command to print the images through the user input portion 210, the print portion 230 prints the processed and edited resultant images that the processing and editing portion 220 temporarily stores (operation 140).

In a conventional printer, a sheet of an image is printed through a simple edition and a next image is printed thereafter. However, in the printer according to the present general inventive concept, all desired images are processed and edited and the resultant images are printed at a time so that the user's convenience is improved.

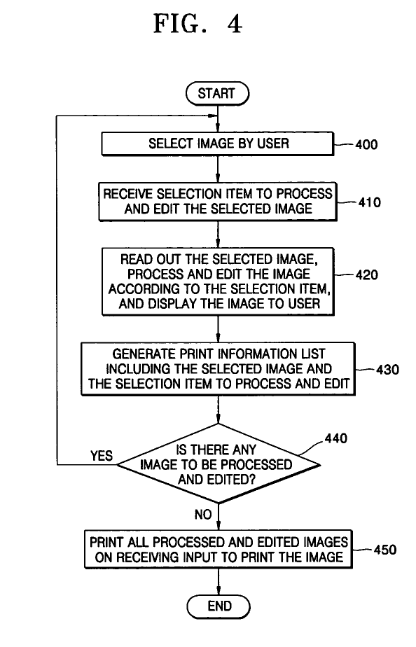

FIG. 4 is a flow chart illustrating a method of processing and editing a plurality of images and printing the processed and edited images at a time according to another embodiment of the present general inventive concept. Referring to FIG. 4, the method of processing and editing images using a printer includes user's selecting an image to be printed (operation 400), receiving an input on a predetermined selection item to process and edit the image selected at operation 400 (operation 410), reading out the selected image and processing and editing the same according to the selection item and displaying the same to the user (operation 420), generating a print information list including the image selected at Operation 400 and the selection item to process and edit the image (operation 430), and determining whether there is another image to process and edit (operation 440). If there is the another image to be processed and edited at Operation 440, and after the user selects the another image to be printed the operations 410 through 430 are repeated to process and edit the image to be printed so that the processed another image is displayed to the user and a print information list corresponding to each image to be printed is generated. If there is no other image to be processed and edited at operation 440, by receiving a user's input to print all processed and edited images, all processed and edited images displayed to the user are printed at a time according to the print information list generated at operation 430 (operation 450).

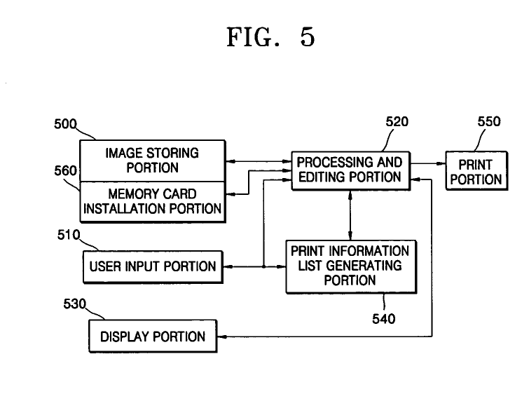

FIG. 5 is a block diagram illustrating an apparatus to process and edit a plurality of images and to print the processed and edited images at a time according to another embodiment of the present general inventive concept. Referring to FIG. 5, the apparatus to edit and print an image includes an image storing portion 500 to store image data corresponding to images, a user input portion 510 to receive a user's selection of the image data to be printed stored in the image storing portion 500, a predetermined selection item to process and edit the image, and an instruction to print the image, a processing and editing portion 520 to read out the image selected through the user input portion 510 from the image storing portion 500 and processing and editing the image according to the selection item to process and edit the image, a print information list generating portion 540 to generate a print information list including the processed and edited image and the selection item to process and edit the image, and a print portion 550 to print the image processed and edited by the processing and editing portion 520 according to the print information list generated by the print information list generating portion 540 upon receiving an input to print the processed and edited image received through the user input portion 510.

The method of FIG. 4 and the apparatus of FIG. 5 are similar to the method of FIG. 1 and the apparatus of FIG. 2, respectively. In the descriptions of FIGS. 4 and 5, the same operations and functions as those described with reference to FIGS. 1 and 2 will be omitted herein.

The image storing portion 500, the memory card installation portion 560, the user input portion 510, and the display portion 530 have substantially the same functions as the image storing portion 200, the memory card installation portion 250, the user input portion 210, and the display portion 240, respectively.

When the user selects the image at operation 400 and inputs the selection item to process and edit the selected image at operation 410, the processing and editing portion 520 reads out data corresponding to the selected image from the image storing portion 520 and processes and edits the image according to the selection item to process and edit selected by the user to display the resultant image to the user at operation 420. Examples of images to be displayed to the user are shown in FIGS. 3A through 3D.

The print information list generating portion 540 may generate the print information list regarding images at operation 430 only when the processing and editing portion 520 processes and edits the image, a resultant image thereof is displayed to the user through the display portion 530, and the user confirms the result thereof. Since only the images confirmed by the user are printed, there may be no need to generate the print information list with respect to all of the processed and edited images.

When the processing and editing portion 520 reads out the image selected by the user from the image storing portion 500 and processes and edits the image according to the user's selection item at operation 420, for example, while seeing the displayed image, the user selects the image contrast adjustment as the selection item to process and edit the image. When the user adjusts a contrast of the image using the key pad of the user input portion 510, the processing and editing portion 520 displays a result of the adjustment through the display portion 530. When the user confirms or selects the result, a contrast value of the adjusted image at that time is used as a value of an image contrast value field of the print information list generating portion 540.

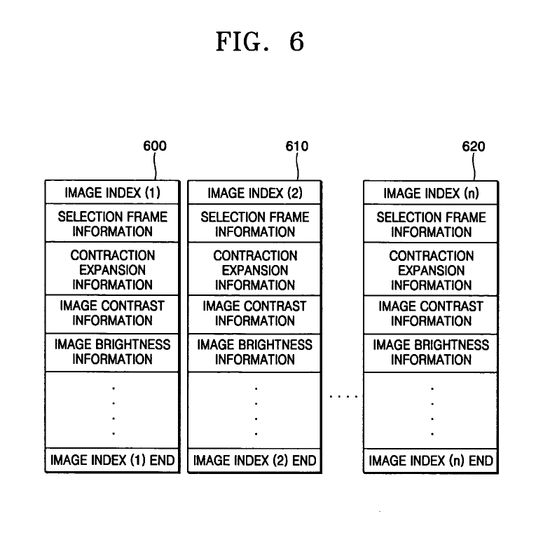

FIG. 6 shows examples of a print information lists 600, 610, and 620 generated from the apparatus of FIG. 5. The print information list 600 regarding a first image includes information on items selected by a user regarding processing and editing of an image, such as an index field indicating the first image, a fame information field selected with respect to the image, an information field on selection by the user regarding contraction or expansion of the image, an information field on contrast processing with respect to the image, and an information field on a change about brightness of the image. The print information list 610 regarding a second image includes the same fields as those for the first image, and the same is the print information list 620 regarding an n-th image.

For the information field regarding the contraction or expansion of each image, for example, +120 in a case of expansion, −70 in a case of contraction, and 0 in a case of maintaining an original size of the image may be recorded. The image brightness information field may be recorded by a value between 0 and 100.

A certain image may be printed without being processed and edited. In this case, a value of each field of the print information list regarding the image may be a value with respect to the original image.

The type of the fields with respect to the selection items on processing and editing an image is a mere example. It is possible that other selection items on various image processing can be added. Since a detailed method on the image processing can be embodied using well-known technologies, an additional description thereof will be omitted.

After the user confirms the selection items to process and edit the images selected by the user, the print information list generating portion 540 generates the print information list 600, 610, or 620 as shown in FIG. 6 with respect to all images to be printed. When the user inputs a command to print all images through the user input portion 510, the print portion 550 prints the images processed and edited according to the print information list generated by the print information list generating portion 540 at operation 450.

In a case of performing the printing in the apparatus shown in FIGS. 1 and 2, the processing and editing portion 520 processes and edits images and outputs resultant images that are temporarily stored. In this case, although a user convenience can be improved compared to a conventional printer, a space for temporarily storing the processed edited images which requires an increase of a memory capacity of the printer. To this end, manufacturing costs are increased to embody such a printer. Also, processing a large number of images may be difficult due to a limitation on an inner space of the printer where memory devices are installed. However, as it will be described later, since the printer according to the present invention shown in FIGS. 1 and 2 prints the previously generated resultant images, a processing speed becomes fast.

As an embodiment of the printing apparatus shown in FIGS. 4 and 5, like a case of FIGS. 1 and 2, the print portion 550 can print the resultant images processed and edited and temporarily stored by the processing and editing portion 520 according to the print information list generated by the print information list generating portion 540.

As another embodiment of printing according to the present invention shown in FIGS. 4 and 5, the processing and editing portion 520 does not store the resultant images corresponding to the confirmation received by the user, and the print information list generating portion 540 generates the print information list with respect to the resultant images. The print information list is generated with respect to all images. During printing, the print portion 550 referring to the first print information list 600 controls the processing and editing portion 520 to read out the first image stored in the image storing portion 500 and regenerate the resultant image processed and edited according to the value stored in the image processing and editing field recorded in the print information list. In this case, there may be no need to display the image to the user. The print portion 550 prints the regenerated resultant image.

In the above case, since all the resultant images processed and edited by the processing and editing portion 520 do not need to be stored, an additional memory device to store the images is not needed. Thus, the size of a printed can be made compact. Compared to the case shown in FIG. 1 or 2, in which all the resultant images are temporarily stored and printed, the printing speed may become slower due to a time required to prepare for printing. In a case shown in FIG. 4 or 5, if an image in the next print information list is processed while the first resultant image is being printed, the above preparation time can be reduced.

Also, it is possible that the respective operations according to the present general inventive concept can be variously embodied as software or hardware using a general programming technique.

The general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over a network coupled the computer systems so that the computer readable code is stored and executed in a distributed fashion.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of processing and editing a plurality of images and printing the processed and edited images using a printing apparatus, the method comprising:
receiving a first image to print:
receiving a predetermined selection item to process and edit the first image, reading out the first image, and processing and editing the read first image according to the selection item;
receiving a second image to print;
processing and editing the second image; and
printing the processed and edited first and second images at a time according to an input to print the processed and edited first and second images.

2. The method of claim 1, wherein the receiving of the first and second images to print comprises receiving the first and second images selected by a user among a plurality of images including the first and second images, and displaying the first and second images selected by the user.

3. The method of claim 1, wherein the receiving, reading out, processing and editing of the first and second images comprises receiving a third image to print, reading out the third image, and processing and editing the read third image according to the selection item, displaying a result of processing and editing the first, second, and third images according to the selection item, and receiving from the user confirmation to print the processed and edited first and second images among the processed and edited first, second, and third images, that the processed and edited first and second images are printed at a time in the printing apparatus while the processed and edited third image is not printed.

4. The method of claim 3, wherein the selection item comprises a first item, a second item, and a third item, and the receiving, reading out, and processing and editing of the first, second, and third images comprise:
receiving the first, second, and third items to process and edit the first, second, and third images, respectively;
displaying a first result of processing and editing the first image according to the received first item, a second result of processing and editing the second image according to the received second item, and a third result of processing and editing the third image according to the received third item; and
receiving confirmation regarding the displayed first, second, and third results corresponding to the processed and edited first, second, and third images, respectively, to select the processed and edited first and second images to be printed.

5. The method of claim 4, wherein the displaying of the first result comprises displaying the first image which is not processed and edited, and the processed and edited first image.

6. The method of claim 1, wherein the selection item comprises a first item and a second item, and the receiving, reading out, and processing and editing of the first and second images comprise:
receiving the first item and the second item to process and edit the first image and the second image, respectively;
displaying a first result of processing and editing the first image according to the received first item, and a second result of processing and editing the second image according to the received second item; and
receiving confirmation regarding the displayed first and second results corresponding to the processed and edited first and second images, respectively, to select the processed and edited first and second images to be printed.

7. The method of claim 6, wherein the displaying of the first result comprises displaying the first image which is not processed and edited according to the first item, and the processed and edited first image, and the displaying of the second result comprises displaying the second image which is not processed and edited according to the second item, and the processed and edited second image.

8. The method of claim 1, wherein the receiving of the input regarding the selection item comprises receiving at least one of an image contrast adjustment, a brightness adjustment, a boundary adjustment, an image reduction, an image enlargement, and a frame selection as the selection item.

9. The method of claim 1, wherein the processing and editing of the first image comprises receiving a first sub-image, displaying the first image and the first sub image on a first portion and a second portion of a screen, respectively, and printing an image including the first image and the first sub image as the processed and edited first image.

10. The method of claim 9, wherein the displaying of the image comprises displaying the image and the first image which is not processed and edited, on the first portion and the second portion of the screen, respectively.

11. The method of claim 1, wherein the printing apparatus comprises a display to display, and the processing and editing of the first and second images comprises displaying at least one of the first image, the second image, the processed and edited first image, and the processed and edited second image, on a screen of the display.

12. The method of claim 11, wherein the display is installed in the printing apparatus.

13. The method of claim 11, wherein the receiving of the first and second images comprises receiving the selection item through the screen of the display of the printing apparatus.

14. The method of claim 11, wherein the receiving of the second image comprises receiving the second image to process and edit the received second image, after the first image is received, read out, and processed and edited.

15. The method of claim 1, wherein the printing apparatus comprises a memory card installation portion to read data from a predetermined memory card which is inserted therein and contain a plurality of images including the first and second images, and the receiving of the first and second images to print comprises selecting and reading out the first and second images from the memory card inserted in the memory card installation portion.

16. The method of claim 1, wherein the printing apparatus is connected to a computer to store a plurality of images including the first and second images, and the receiving of the first and second imaged to print selecting and reading out the first and second images stored in the computer connected to the printing apparatus.

17. A method of processing and editing a plurality of images and printing the processed and edited images using a printing apparatus, the method comprising:
receiving a first image and a second image to print:
receiving a predetermined selection item to process and edit the first and second images, reading out the first and second images, processing and editing the first and second images according to the selection item, and displaying the processed and edited first and second images;
generating a print information list corresponding to the processed and edited first image and the selection item to process and edit the first image;
generating the print information list corresponding to the second image to print; and
printing the processed and edited first and second images at a time according to the print information list and an input to print the processed and edited first and second images.

18. The method of claim 17, wherein the receiving of the first and second images to print comprises selecting the first and second images from a plurality of images, and displaying the selected first and second images.

19. The method of claim 17, wherein the receiving, reading out, and processing and editing of the first and second images comprises displaying a first result of processing and editing the first image and a second result of processing and editing the second image, according to the selection item, and receiving confirmation to print the displayed first and second results.

20. The method of claim 19, wherein the selection item comprises a first item and a second item to process and edit the first and second images, respectively, and the receiving, reading out, and processing and editing of the first and second images comprises:
receiving the first item to process and edit the first image;
displaying a first result of processing and editing the first image according to the received first item;
receiving a first confirmation regarding the displayed first result; and
receiving the second item to process the second image;
displaying a second result of processing and editing the second image according to the received second item; and
receiving a second confirmation regarding the displayed second result, so that the first and second results are printed at a time.

21. The method of claim 20, wherein the displaying of the first result comprises displaying the first image which is not processed and edited, and the first result of processing and editing of the first image according to the first item.

22. The method of claim 17, wherein the print information list comprises a first print information list corresponding to the first image and the first item and a second print information corresponding to the second image and the second item.

23. The method of claim 17, wherein the printing apparatus comprises a memory card installation portion to store data corresponding to a plurality of images including the first and second images, and, the receiving of the first and second images to print comprises selecting the first and second images from the memory card.

24. The method of claim 17, wherein the printing apparatus is connected to a computer storing a plurality of images including the first and second images, and the receiving the first and second images to print comprises selecting the first and second images from the computer connected to the printing apparatus.

25. An apparatus to process and edit a plurality of images and to print the processed and edited images, the apparatus comprising:
an image storing portion to store image data corresponding to first and second images;
a user input portion to receive an input to select the first and second images from the image storing portion to print, an input to correspond to a predetermined selection item to process and edit the first and second images, and an input to perform printing;
a processing and editing portion to read out the first and second images from the image storing portion and to process and edit the first and second images according to the selection item; and
a print portion to print the processed and edited first and second images at a time according to the input to print the processed and edited first and second images.

26. The apparatus of claim 25, further comprising:
a display portion to display the first and second images selected by a user, and the processed and edited first and second images.

27. The apparatus of claim 26, wherein the use input portion receives confirmation from the user, and the processing and editing portion displays a result of processing and editing of the first and second images according to the selection item input by the user, to the user through the display portion, according to a confirmation input through the user input portion.

28. The apparatus of claim 27, wherein the selection item comprises a first item and a second item, the confirmation comprises a first confirmation and a second confirmation to select the processed and edited first and second images, respectively, the processing and editing portion processes and edits the first and second images according to the first and second items, respectively, the display portion displays the processed and edited first and second images, and the printing portion prints the processed and edited first and second images at a time according to the first confirmation and the second confirmation.

29. The apparatus of claim 28, wherein the display portion displays the first image that is not processed and edited and a result of processing and editing of the first image.

30. The apparatus of claim 25, wherein the image storing portion comprises a memory card installation portion to read data from a predetermined memory card inserted therein, and the processing and editing portion reads out the first and second images stored in the memory card when the first and second images stored in the memory card inserted in the memory card installation portion are selected.

31. The method of claim 25, wherein the selection item comprises at least one of an image contrast adjustment, a brightness adjustment, a boundary adjustment, an image reduction, an image enlargement, and a frame selection.

32. The method of claim 25, wherein the processing and editing portion combine the first image and a first sub-image as the processed and edited first image, and the printing portion prints an image including the first image and the first sub image as the processed and edited first image.

33. The method of claim 32, further comprising:
a display portion to display the image and the first image which is not processed and edited, on the first portion and the second portion of the screen, respectively.

34. The method of claim 25, further comprising:
a display portion to display at least one of the first image, the second image, the processed and edited first image, and the processed and edited second image, on a screen thereof to select the processed and edited first image and the processed and edited second image to be printed at a time.

35. The method of claim 34, wherein the display portion is installed in the printing apparatus.

36. The method of claim 34, wherein the user input portion received the selection item through the screen of the display portion.

37. The method of claim 25, wherein the user input portion receives the second image after the first image is received, read out, and processed and edited, and the processed and edited first and second images are printed at a time.

38. An apparatus to process and edit a plurality of images and to print the processed and edited images, the apparatus comprising:
an image storing portion to store image data corresponding to first and second images;
a user input portion to receive an input to select the first and second images from the image storing portion, an input to correspond to a predetermined selection item to process and edit the first and second images, and an input to perform printing;
a processing and editing portion to read out the first and second images selected through the user input portion from the image storing portion and to process and edit the first and second images according to the selection item;
a display portion to display the first and second images and the processed and edited first and second images processed and edited by the processing and editing portion;
a print information list generating portion to generate a print information list including the processed and edited first and second images, and the selection item; and
a print portion to print the processed and edited first and second images at a time according to the print information list and the input to print the processed and edited first and second images.

39. The apparatus of claim 38, wherein the use input portion receives a confirmation to select at least one of the processed and edited first and second images, the processing and editing portion displays a first result of processing and editing of the first image and a second result of processing and editing of the second image through the display portion, and the print information list generating portion generates the print information list to include the at least one of the processed and edited first and second images according to the confirmation.

40. The apparatus of claim 39, wherein the selection item comprises a first item and a second item, the confirmation comprises a first confirmation and a second confirmation to select the processed and edited first and second images, respectively, the processing and editing portion processes and edit the first and second images according to the first and second items, respectively, displays the processed and edited first and second images through the display portion, receives the first confirmation and the second confirmation to display the processed and edited first and second images according to the first confirmation and the second confirmation, respectively.

41. The apparatus of claim 38, wherein the display portion displays the first image that is not processed and edited, and a result of processing and editing of the first image.

42. The apparatus of claim 38, wherein the image storing portion comprises a memory card installation portion to read data from a predetermined memory card inserted therein, and the processing and editing portion reads out the first and second images stored in the memory card when the memory card is inserted in the memory card installation portion.

43. A computer readable storage medium to perform a method of processing and editing a plurality of images and printing the processed and edited images using a printing apparatus, the method comprising:
receiving a first image to print:
receiving a predetermined selection item to process and edit the first image, reading out the first image, and processing and editing the read first image according to the selection item;
receiving a second image to print;
processing and editing the second image; and
printing the processed and edited first and second images at a time according to an input to print the processed and edited first and second images.
